(19) United States
(12) Patent Application Publication
(10) Pub. No.: US 2006/0089873 A1
(43) Pub. Date: Apr. 27, 2006

(54) Salon-spa business method

(76) Inventors: Harold O. Stewart JR., Savannah, GA (US); Mary Elinda Nelson, Charleston, SC (US)

Correspondence Address: HAROLD O. STEWART JR., 703 YEW ST., CHARLESTON, SC, 29407, US

(21) Appl. No.: 10/969,816

(22) Filed: Oct. 21, 2004

(51) Int. Cl. G06Q 30/00

(52) U.S. Cl. 705/14

(57) ABSTRACT

A method of operating a beauty salon-spa, includes a salon-spa program, wherein a member of the salon-spa program signs a service agreement, pays a monthly fee for an effective period of the service agreement, and receives a service package, comprising a plurality of salon-spa-related services, every month for the effective period.

### CROSS REFERENCE TO RELATED DOCUMENT

This invention was described in the ______ which was received by the U.S. Patent & Trademark Office ______.

### BACKGROUND OF THE INVENTION

1. Technical Field

The present invention relates to a business method for operating a beauty salon-spa involving a salon-spa program.

2. Background Information

Professional beauty products and services and professional massage sessions are in general quite expensive. In order to attract customers and run a profitable business, it is a benefit to a beauty-related business to be able to sell these products, services, and sessions at a discount. Salons and spas sometimes distribute coupons for one-time purchases, services, or sessions; however, there do not appear to be any beauty-related businesses in existence that offer continuous, discounted, professional beauty products, beauty services, and massage sessions. The salon-spa business method of the present invention offers these products, services, and sessions bundled in a discounted service package.

### BRIEF SUMMARY OF THE INVENTION

The business method of the present invention for operating a beauty salon-spa comprises a salon-spa program, wherein a member of the salon-spa program signs a service agreement, pays monthly fees for an effective period of the service agreement, and receives a service package, comprising a plurality of services, every month for the effective period. Examples of different service packages are an all-inclusive service package, a hair-only service package, a nail-only service package, a massage-only service package, or a combination thereof. The service package may also include additional benefits available only to members. The member receives the services included in the service package at a discount from the fee for each service without the service package. Initially, a beauty salon-spa utilizing the present business method publicly advertises to attract customers, also known as prospective members, to the salon-spa program. Once the salon-spa program includes a pre-determined number of members, the salon-spa ceases public advertisement of its products and services and relies mainly upon word of mouth of satisfied members to attract prospective members.

The salon-spa business method of the present invention additionally comprises a first process of serving a customer, a second process of serving a customer, and a process of a customer's transition from a prospective member to a member. Furthermore, the salon-spa business method comprises a guide sheet for distribution to and use by employees, and a survey for distribution to both prospective member and members and for improvement of the salon-spa program.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a flowchart showing a first process of serving a customer at a salon-spa according to the business method of the present invention;

FIG. 2 is a flowchart showing a process of a salon-spa customer's transition from a prospective member to a member according to the business method of the present invention;

FIGS. 3A-C are sections of a flowchart showing a second process of serving a customer at a salon-spa according to the business method of the present invention;

FIG. 4 is a sample service agreement for a hair-only service package according to the business method of the present invention;

FIG. 5 is a guide sheet for use by salon-spa employees according to the business method of the present invention; and

FIG. 6 is a sample customer survey according to the business method of the present invention.

### DETAILED DESCRIPTION OF THE INVENTION

In the following description, like reference characters designate like or corresponding parts throughout the several views. Referring in more detail to the drawings, the invention will now be described.

The present invention is a business method for operating a beauty salon and/or spa comprising a salon-spa program. An initial step of the business method for operating a beauty salon-spa according to the present invention is advertising to the public to attract customers to the beauty salon-spa. The beauty salon-spa may employ any suitable method of advertisement to advertise its services, such as bulk mailings, newspaper and magazine advertisements, radio commercials, television commercials, flyers, e-mail, internet pop-up advertisements, telemarketing, and/or door-to-door salesmen.

During this initial advertising phase, when a customer patronizes the beauty salon-spa for the first time, the customer is a “prospective member”. The customer may walk in, or have a pre-scheduled appointment. The salon-spa business method further comprises greeting the prospective member, obtaining basic customer information from the prospective member, and entering the basic customer information into a customer database. This is done by a first salon-spa employee, most preferably a receptionist at the front of the beauty salon-spa. The basic customer information includes a name, an address, and at least one telephone number for the prospective member. In the present method, a software program on a computer preferably stores the customer database. The first salon-spa employee then categorizes the prospective member into a Stage 1 category within the customer database. Prospective members that have visited the salon-spa only once to receive a beauty product or service are placed into Stage 1. At this stage, the prospective members are usually “shopping”: comparing prices and standards at different salons or spas.

Next, the first salon-spa employee informs the prospective member of the availability of the instant salon-spa program, which can be accessed by signing a service agreement and paying a monthly fee. The first salon-spa employee can explain the salon-spa program verbally with or without visual aids that describe the salon-spa. Alternatively, the first salon-spa employee can simply hand the prospective member a visual aid that describes the salon-spa program. Examples of such visual aids are brochures, posters, flyers, and advertisements describing the present salon-spa program and the service agreement.

According to this proprietary salon-spa program, which is preferably called Maryonie's Hair Design Images, prospective members who sign the service agreement indicating that they agree to terms of the service agreement are deemed “members”. The service agreement requires each member to pay an agreed upon monthly fee to the salon-spa for the duration of the effective period of the service agreement. In consideration of the monthly fee, the member receives a pass that entitles the member to a service package. The effective period is preferably six (6) months or one (1) year beginning on the day the prospective member signs the service agreement.

The pass has preferably captures a copy of the member customer service agreement with instructions for the employee reading the pass information regarding which services to provide. This pass can swipe like a credit card. It has a magnetic strip or a microchip that includes data or adds data, including the number of times each service is provided over the period of the service agreement. Each pass has its own issue number to maintain its individuality. A pass can interface with software or a kiosk to provide exchanges, or add services and data advertisement as added by the service agreement. The pass can be used with other business to business transaction in beauty service to provide substantial discounts for member services to receive beauty enriching services either for beauty products and services, or health care. This can only be provided with pass technology. It can be used on condition with the beauty capitation insurance program described below.

Preferably, the monthly fee is due on the first day of each month, with the monthly fees for the first month and the last month of the effective period being pro-rated. The service agreement may include a grace period, beginning on the second day of each month, during which the member may pay the monthly fee late without penalty. After the grace period expires, any member who pays the monthly fee late is subject to payment of late charges as specified in the service agreement. Additionally, the service agreement preferably includes terms allowing the member to initially pay up-front a lump sum equal to the sum of the monthly fees for the months included in the effective period, as well as terms allowing the member, at any time, to pay a lump sum equal to the sum of the monthly fees for the months remaining in the effective period.

The service package may be an all-inclusive service package, a hair-only service package, a nail-only service package, a massage-only service package, or a combination thereof. Each month, the hair-only service package includes the following services, which are provided by a number of hair stylists and other employees of the salon-spa:

(a) a pin-up of the member's hair or a full hair design, including sewn-in human or synthetic hair;

(b) a permanent upon recommendation by a hair stylist;

(c) tightening;

(d) bumping;

(e) hair cuts;

(f) unlimited consultations with hair stylists/employees of the salon-spa;

(g) prompt, professionally scheduled appointments;

(h) guest passes for guests of members to receive salon-spa services; and

(i) an aromatherapy treatment.

A full hair design is a full designer's look for a member, which includes an abstract design created uniquely for the member. It includes a hair piece using human or synthetic hair to provide a fuller look of hair for the scalp to ensure transformation of beauty that can build up members' self-esteem, pride, and sense of well being. This process includes a unique sewing pattern of a braiding process of one's own hair to provide a foundation for the desired result. In contrast, a pin-up includes adding high quality human hair to achieve a fuller look of hair in a more central position. The pin-up provides several arrangements of uniquely places pieces of added hair on the scalp.

The hair-only service package also includes:

(a) three (3) hair washings during the three (3) weeks immediately following the signing of the service agreement; and

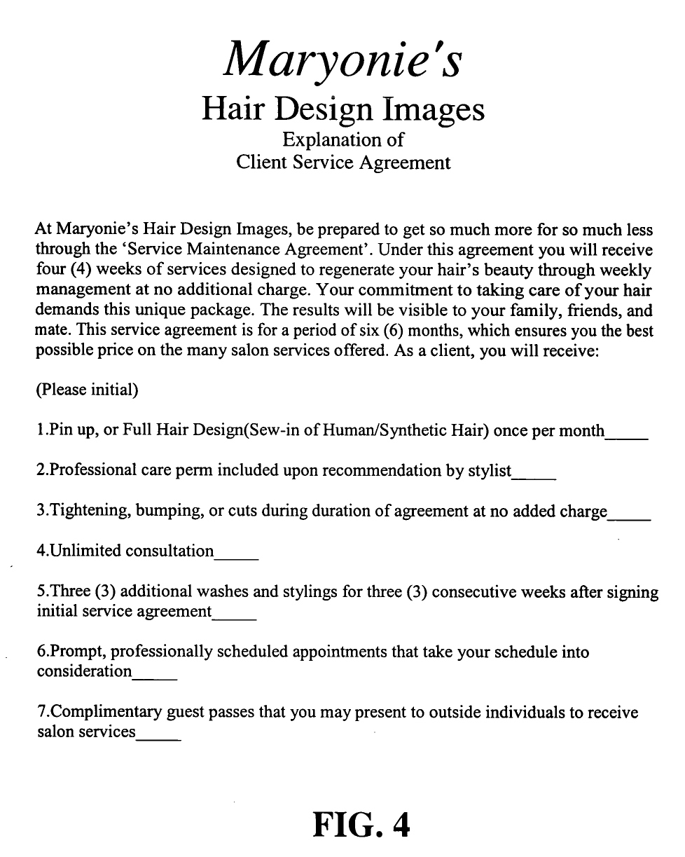

(b) three (3) hair stylings during the three (3) weeks immediately following the signing of the service agreement. FIG. 4 shows a sample service agreement for the hair-only service package. The service package is designed to stimulate hair follicles. This is believed to help extend the growth cycle, and allow for each hair strand to become stronger and longer in size, shape and form.

Other service packages may originate from other service providers that are not beauty care providers, although they do contribute to an overall feeling of being beautiful (see the beauty capitation insurance program, below). In addition to this insurance program is subscribed to and is separate from the service agreement herein, but information acquired by way of the service agreement can be used to support the beauty capitation program.

Members of the salon-spa program preferably receive other benefits in addition to the services included in their service packages. Examples of such benefits are a free subscription to a quarterly hair magazine, free admission to an annual hair-related trade show, free beauty care products, and other related service consultations.

The sum of the monthly fees for the effective period of the service agreement, called the “first sum”, is less than the sum of regular fees for all services included in the service package, called the “second sum”. Thus, the member receives the services included in the service package at a discount. It is therefore a financial advantage for frequent patrons of the salon-spa to participate in the salon-spa program of the present invention.

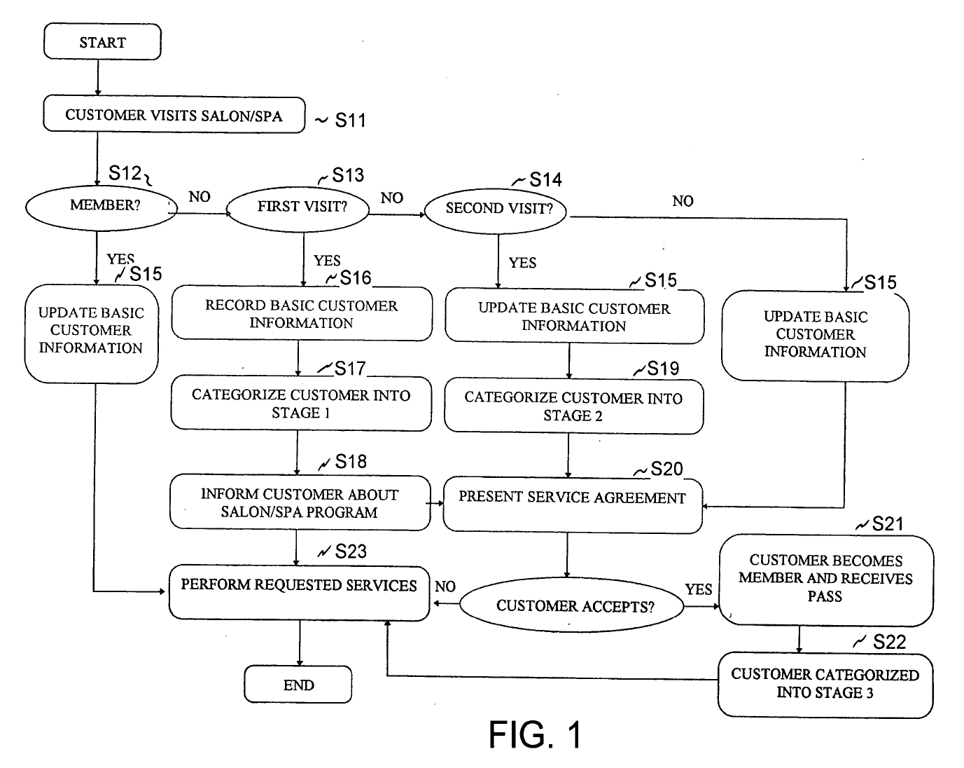

Turning to FIG. 1, the salon-spa business method according to the present invention comprises a first process of serving a customer, either a prospective member or a member, at the salon-spa. The first process of serving a customer comprises the following steps, S11-S30.

Step S11: A customer visits the salon-spa. The customer may walk in or have a pre-scheduled appointment.

Step S12: The first salon-spa employee, preferably a receptionist, ascertains whether the customer is a prospective member or a member. The first salon-spa employee may ask the customer if he or she is a prospective member or a member. If the customer says he/she is a member, the first salon-spa employee asks to see the customer's pass for the salon-spa program and verifies that the pass is valid. If the pass is valid, the process proceeds to Step S15. If the customer says that she or he is a prospective member, the process proceeds to Step S13. Alternatively, the first salon-spa employee may obtain the name of the customer and search the customer database to determine whether the customer is categorized into Stage 1, a Stage 2 category, or a Stage 3 category. By definition, customers who patronize the salon-spa once are categorized in Stage 1 of the customer database. With a second visit to receive a beauty product or service, the customer advances to Stage 2. Stage 2 is an intermediate stage during which relationships with the customer are solidified by learning and satisfying the customer's needs and wants to the extent possible. Stage 2 may include a number of subsequent visits, and may in fact last for a long time. Customers who are members are categorized into Stage 3 of the customer database. Stage 3 is for customers who are “loyalized”, i.e., they have made a decision to stay with the salon-spa. If the customer is categorized in Stage 1 or Stage 2, the customer is a prospective member and the process proceeds to Step S13. If the customer is not in the customer database, the customer is a prospective member and the process proceeds to Step S13. If the customer is categorized in Stage 3, the customer is a member and the process proceeds to Step S15.

Step S13: The first salon-spa employee ascertains whether the prospective member is patronizing the salon-spa for the first time. If the first salon-spa employee has not already determined whether the customer is not categorized, or categorized into Stage 1 or Stage 2, the first salon-spa employee obtains the name of the prospective member and searches the customer database to determine whether the prospective member is in the customer database. If the prospective member is not in the customer database, the prospective member is patronizing the salon-spa for the first time and the process proceeds to Step S16. If the prospective member is in the customer database, the prospective member is not patronizing the salon-spa for the first time and the process proceeds to Step S14.

Step S14: The first salon-spa employee ascertains whether the prospective member is patronizing the salon-spa for the second time. If the salon-spa employee has not already determined whether the customer is categorized in Stage 1 or Stage 2, the first salon-spa employee searches the customer database to determine whether the prospective member is categorized in Stage 1 or Stage 2. If the prospective member is categorized in Stage 1, the prospective member is patronizing the salon-spa for the second time and the process proceeds to Step S15. If the prospective member is categorized in Stage 2, the prospective member has patronized the salon-spa on more than two occasions and the process proceeds to Step S15.

Step S15: The first salon-spa employee obtains current basic customer information from the customer and updates the member's basic customer information in the customer database. If the customer is a member, the process proceeds to Step S23. If the customer is a prospective member patronizing the salon-spa for the second time, the process proceeds to Step S19. If the customer is a prospective member who has patronized the salon-spa at least twice, the process proceeds to Step S20.

Step S16: The first salon-spa employee obtains basic customer information from the prospective member and enters the prospective member's basic customer information into the customer database. The process then advances to Step S17.

Step S17: The first salon-spa employee categorizes the prospective member in Stage 1 of the customer database and the process advances to Step S18.

Step S18: The first salon-spa employee informs the prospective member about the salon-spa program and the different service packages. The first salon-spa employee can explain the salon-spa program only verbally, or verbally using visual aids that describe the salon-spa. Alternatively, the first salon-spa employee can simply hand the prospective member a visual aid that describes the salon-spa program. Examples of such visual aids are brochures, posters, flyers, advertisements, DVDs, CD-ROM, e-mail codes, websites, and the service agreement. The process then advances to Step S20.

Step S19: The first salon-spa employee categorizes the prospective member in Stage 2 of the customer database and the process proceeds to Step S20.

Step S20: The first salon-spa employee presents the service agreement to the prospective member and asks the prospective member if she or he wants to join the salon-spa program. If the prospective member signs the service agreement (indicating acceptance of its terms), and pays the first monthly fee, the process advances to Step S21. If the prospective member does not sign the service agreement and pay the first monthly fee, the process proceeds to Step S23.

Step S21: The prospective member is reclassified as a member, the first salon-spa employee gives the member a pass for the salon-spa program, and the process advances to Step S22.

Step S22: The first salon-spa employee categorizes the new member into Stage 3 of the customer database and the process proceeds to Step S23.

Step S23: At least one second salon-spa employee such as a hair stylist, a nail manicurist, or a massage therapist, performs any beauty-related services that the prospective member or member requests. Smart card technology, such as a microchip holding the service agreement and dates of monthly payments, may be used in place of, or in addition to, a pass. The smart card would be passed from the first salon-spa employee to the second employee, and so forth, with each salon-spa employee using a computer to enter the service they performed that day on the card.

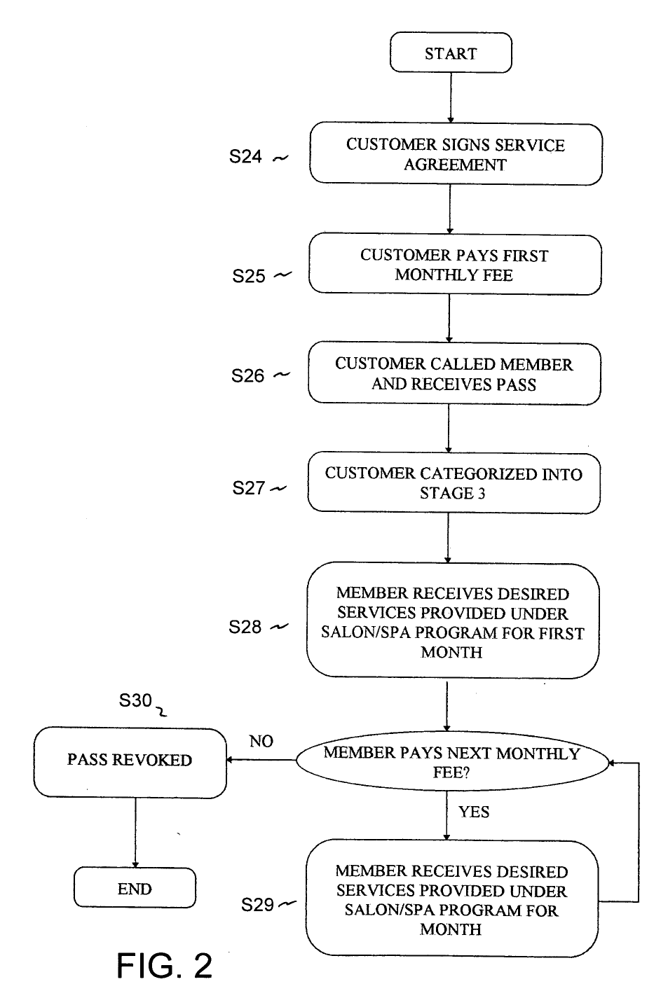

Referring to FIG. 2, the beauty salon-spa business method of the present invention further comprises the customer's transition from a prospective member to a member.

Step S24: The prospective member signs the service agreement, signifying agreement to its terms and the process advances to Step S25.

Step S25: The prospective member pays the first monthly fee and the process advances to Step S26.

Step S26: The prospective member is deemed a member, the first salon-spa employee, most preferably a receptionist, gives the member a pass for the instant salon-spa program, and the process advances to Step S27.

Step S27: The first salon-spa employee categorizes the member into Stage 3 of the customer database and the process proceeds to Step S28.

Step S28: The at least one second salon-spa employee, such as a hair stylist, a nail manicurist, or a massage therapist, provides services to the member included in the service package at no additional charge for the first month of the effective period. The second salon-spa employee also provides beauty-related services requested by the member not included in the service package for an additional fee for each extra service. After the first month of the effective period passes, if the member pays the next monthly fee, the process advances to Step S29. If not, the process proceeds to Step S30.

Step S29: The second salon-spa employee, such as a hair stylist, a nail manicurist, or a massage therapist, provides services to the member included in the service package at no additional charge for the current month of the effective period. The second salon-spa employee also provides beauty-related services requested by the member not included in the service package for an additional fee for each extra service. After the current month of the effective period passes, if the member pays the next monthly fee, Step S29 is repeated. If not, the process proceeds to Step S30.

Step S30: The salon-spa revokes the member's pass for the service package either because the member fails to pay the next monthly fee, or because the effective period of the service agreement expires.

As mentioned in the description of the processes depicted in FIGS. 1 and 2, the salon-spa business method of the present invention comprises three categories into which the salon-spa employee categorizes prospective members and members. Under the present process, Stage 1 prospective members visit the salon-spa once to receive a beauty product or service. Stage 2 prospective members visit the salon-spa at least twice to receive a beauty product or service. Stage 3 is reserved for members. Prospective members and members may also enter the beauty capitation insurance program described below.

After the salon-spa acquires a pre-determined number of members, the salon-spa ceases advertising its services to the public. Instead, the salon-spa relies upon members to attract prospective members. The salon-spa preferably attracts prospective members from nearby salons or spas by word of mouth from satisfied members.

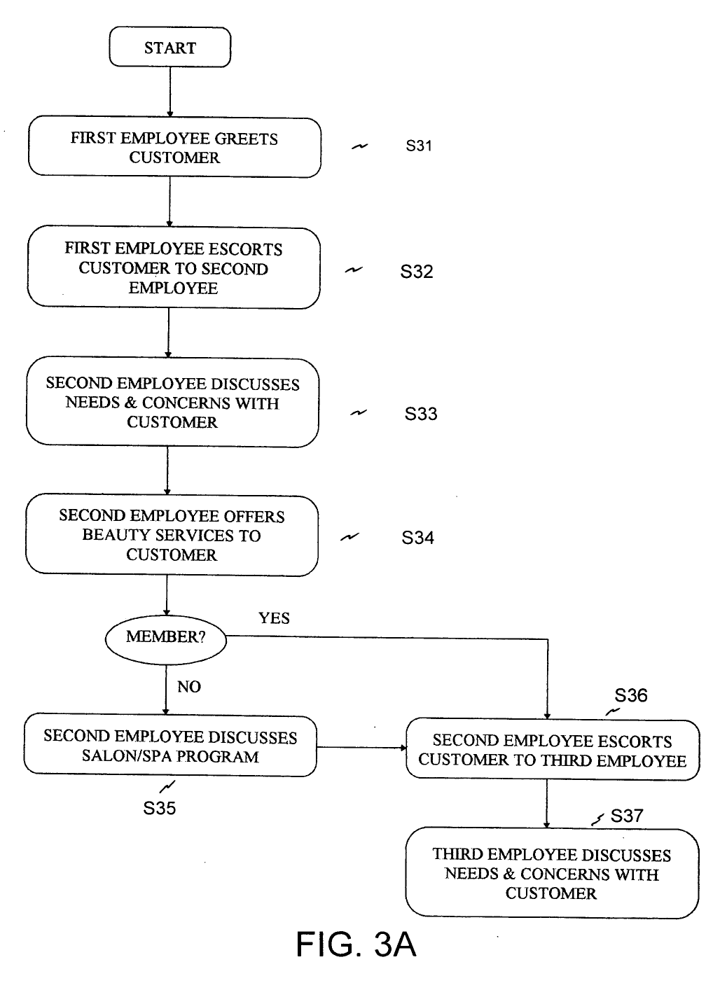

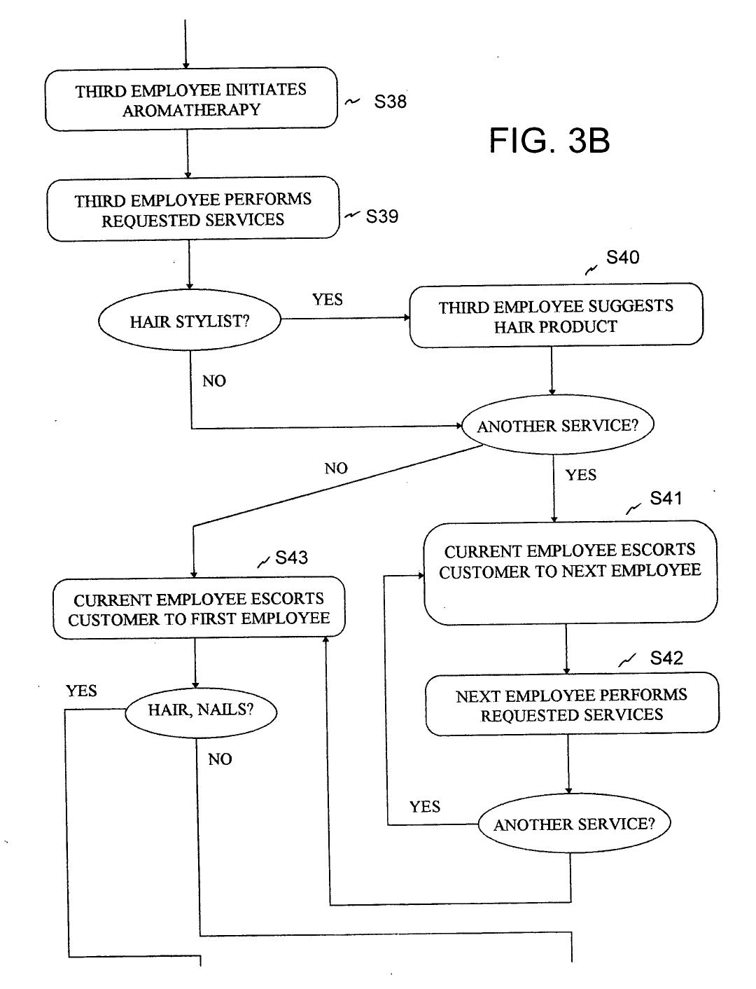

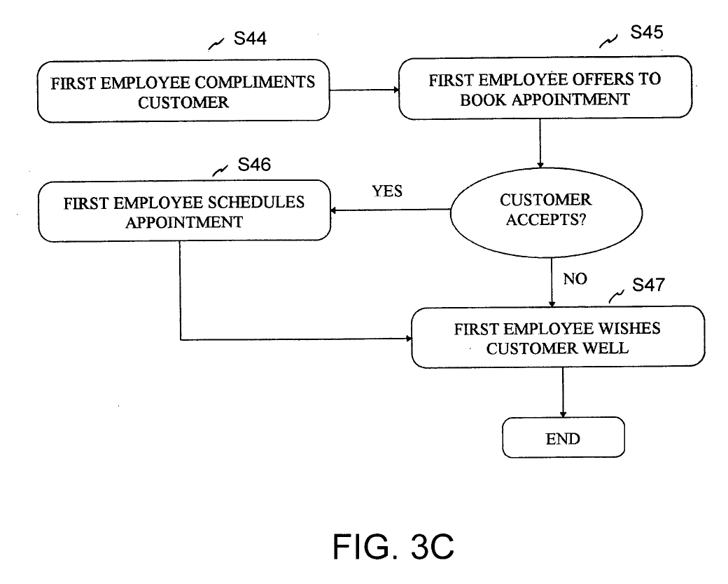

Referring next to FIGS. 3A-C, the salon-spa business method of the present invention comprises a second process of serving a customer, either a prospective member or a member, at a salon-spa. The second process of serving a customer comprises the following steps, S31-S47.

Step S31: The first salon-spa employee, most preferably a receptionist, greets the prospective member or member and the process proceeds to Step S32.

Step S32: The first salon-spa employee escorts and introduces the customer to a second salon-spa employee, such as a preparation artist, make-up consultant, or beauty consultant based on the purpose of the customer's visit. The process then advances to Step S33.

Step S33: The second salon-spa employee discusses the customer's concerns and needs with the customer. The process then proceeds to Step S34.

Step S34: The second salon-spa employee offers beauty services using a specific line of make up/beauty products to the customer. If the customer is a prospective member, the process proceeds to Step S35. If the customer is a member, the process proceeds to Step S36.

Step S35: The second salon-spa employee discusses the salon-spa program, its various service packages, and the advantages of being a member. The process then proceeds to Step S36.

Step S36: The second salon-spa employee escorts and introduces the customer to a third salon-spa employee, such as a hair stylist, a nail manicurist, or a massage therapist, based upon the purpose of the customer's visit. The process then proceeds to Step S37.

Step S37: A third salon-spa employee skilled in aromatherapy discusses the customer's concerns and needs with the customer. The process then proceeds to Step S38.

Step S38: The third salon-spa employee initiates aromatherapy. The process then advances to Step S39.

Step S39: The third salon-spa employee performs services requested by the customer, such as a pin-up of the customer's hair, a full hair design, a permanent, straightening, tightening, bumping, a hair cut, a manicure, a pedicure, or a massage. If the third salon-spa employee is a hair stylist, the process proceeds to Step S40. If the third salon-spa employee is not a hair stylist and the customer requires services from another salon-spa employee, the process proceeds to Step S41. If the third salon-spa employee is not a hair stylist or the customer does not require additional services, the process proceeds to Step S43.

Step S40: The third salon-spa employee suggests at least one product to the customer to maintain the look of the customer's hair and offers the product to the customer for sale. If the customer requires services from another salon-spa employee, the process then proceeds to Step S41. If not, the process proceeds to Step S43.

Step S41: The employee serving the customer escorts and introduces the customer to a next salon-spa employee based upon the customer's needs, and the process proceeds to Step S42.

Step S42: The next salon-spa employee performs services that the customer requests. If the customer requires services from another salon-spa employee, the process returns to Step S41. If not, the process proceeds to Step S43.

Step S43: The salon-spa employee serving the customer escorts the customer to the first salon-spa employee. If the customer had a service performed on her or his hair or nails, the process advances to Step S44. If not, the process proceeds to Step S45.

Step S44: The first salon-spa employee compliments the customer's hair or nails. The process then proceeds to Step S45.

Step S45: The first salon-spa employee offers to book the customer a future appointment. If the customer accepts the offer, the process proceeds to Step S46. If the customer declines the offer, the process proceeds to Step S47.

Step S46: The first salon-spa employee schedules an appointment for the customer. The process then proceeds to Step S47.

Step S47: The first salon-spa employee wishes the customer well.

All beauty salon-spa employees are to be polite, courteous, pleasant, and empathetic towards customers. According to the business method of the present invention, in addition to the duties outlined in the second process of serving a customer, the first salon-spa employee has the following duties:

(a) answering incoming phone calls;

(b) offering appointments within 48 hours to prospective members and members;

(c) offering coffee, tea, doughnuts, and finger sandwiches to prospective members and members;

(d) giving new members complimentary gifts for joining the salon-spa program;

(e) conducting complimentary call sessions;

(f) calling prospective members and members to confirm their appointments;

(g) writing thank you notes;

(h) selling gift certificates;

(i) giving members guest passes; and

(j) scheduling consultations for prospective members and members with salon-spa employees. Complimentary call sessions are set aside times for evaluations for other service providers to set appointments that are under contract with Maryonie's Hair Design.

In addition to the duties described in the second process of serving a customer, the second salon-spa employee has the following duties:

(a) offering beauty consulting services;

(b) describing the cosmetology services included in the different service packages of the salon-spa program to prospective members; and

(c) promoting well-being and a feeling of relaxation.

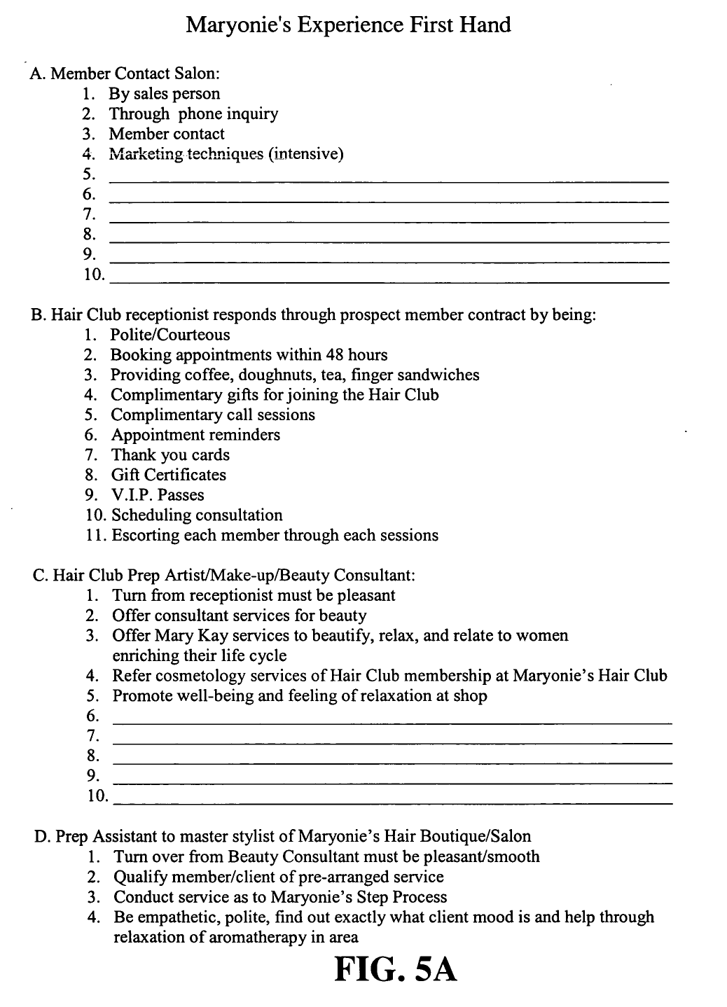

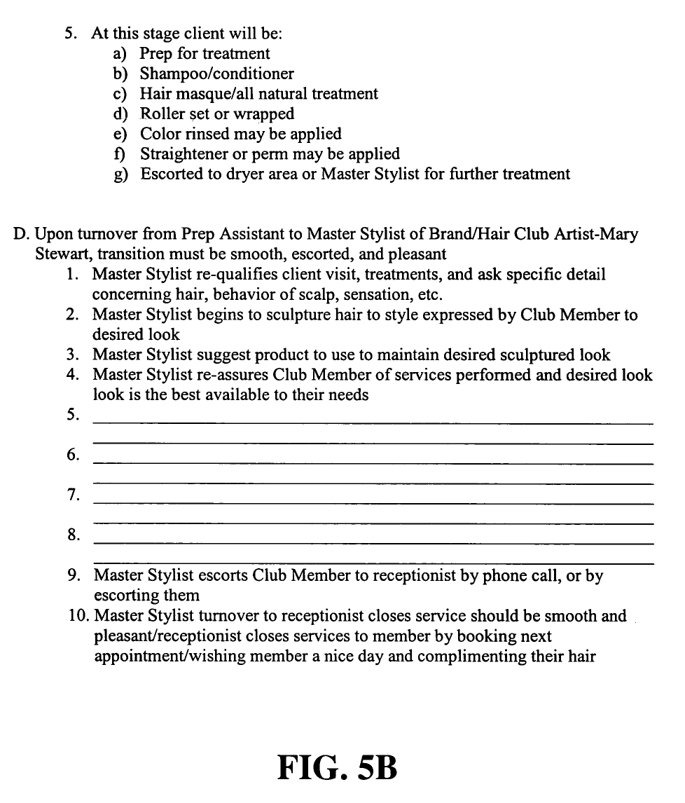

The salon-spa business method preferably comprises distribution of a guide sheet, as shown in FIG. 5, which acts as training material for new salon-spa employees, and a reference guide for all salon-spa employees who deal with prospective members and members.

The beauty salon-spa utilizing the salon-spa business method preferably employs salon-spa employees as follows:

(a) at least one hair stylist;

(b) at least one nail manicurist;

(c) at least one aesthetician;

(d) at least one preparation artist;

(e) at least one make-up consultant;

(f) at least one beauty consultant;

(g) at least one massage therapist; and

(h) at least one receptionist. One employee may serve two functions. A preparation artist is an employee, such as a receptionist, who provides and accommodates member services to assure satisfaction.

The salon-spa utilizing the present salon-spa business method preferably offers the following services:

(a) full service hair styling;

(b) a full service pedicure;

(c) a full service manicure;

(d) a full service 24-point beauty treatment;

(e) customer assistance in selecting and using beauty products, such as shampoos, conditioners, hair coloring products, hair sprays, hair gels, hair mousses, other hair products, and make-up;

(f) an aromatherapy treatment;

(g) a massage; and

(h) a make-over.

Full service hair styling entails all hair styling techniques that do not include “full hair design” service. A full hair design includes a hair piece using human or synthetic hair to provide a fuller look of hair for the scalp. A full service pedicure/manicure is provided by a licensed nail technician. Types of massage include: seat massage, tissue massage, and different types of relaxing and reflexing techniques that include visceral as well as mental stimulation. A beauty care make-over includes the application of makeup on the member's face and instructions regarding the application regimen.

During the aromatherapy treatment, the member reclines and inhales at least one essential oil offered by the salon-spa. Preferably, the essential oils offered by the salon-spa include eucalyptus, spearmint, cedarwood, sage, blue lavender, palmarosa, lavender, vanilla, sweet bay, rose, chamomile, neroli, bergamot, corlander, orange, ginger, grapefruit, and peppermint.

Preferably, the salon-spa business method also involves salon-spa employees utilizing a computer software program that automates the salon-spa business method. The computer software program incorporates the daily layout and functions of the salon-spa business method. It also allows salon-spa employees to provide a preview of beauty transformation for prospective members and members before the beauty services are performed at the salon-spa. It also includes interfacing e-commerce design technology.

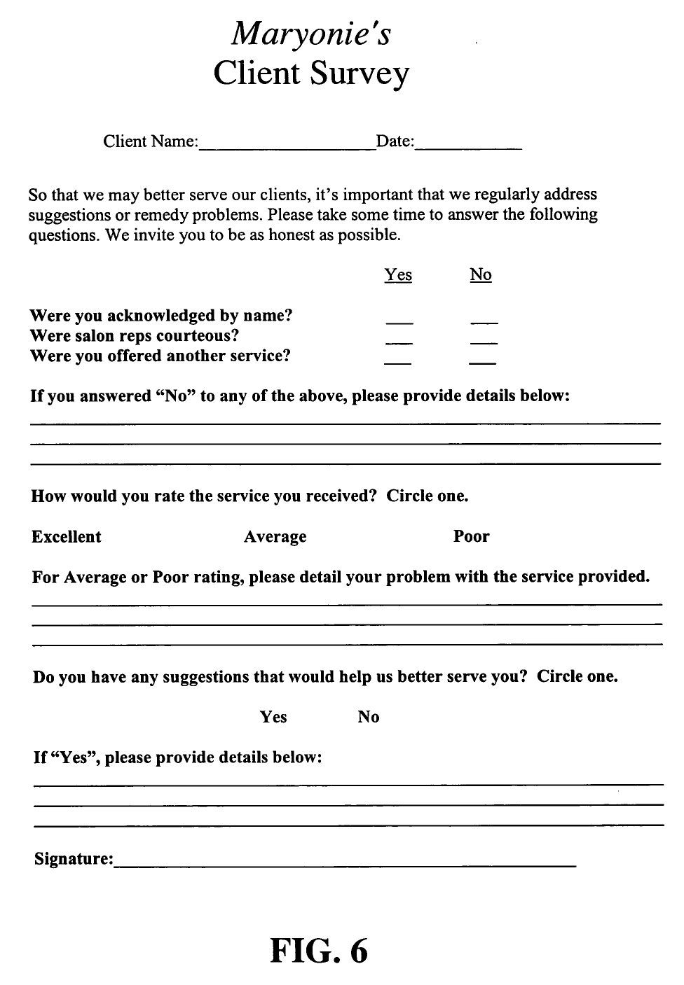

Customer satisfaction is of paramount importance in the present salon-spa business method. Therefore, both prospective members and members are surveyed often. FIG. 6 is an example of an appropriate customer survey.

Also included herein is a beauty care capitation insurance plan, which is a business system and method for management of a consumer membership subscription service for beauty care insurance and a “Beauty Care Benefit Plan”. This program provides a training manual and written manuscripts that describe in detail system interface and methodology for the beauty benefit program. This program includes and is not limited to technology, software, information and industry knowledge dealing in the field of design in forming and operating a beauty capitation payment system, beauty layout design innovative procurement method system for beauty care benefits, without going to traditional service providers that charge a fee for service payment plan for services rendered in the area of beauty for an individual. It interfaces financial contractual arrangements, and business systems and process management with benefits under this beauty capitation insurance plan.

This beauty care insurance program will provide for all beauty care, and personal appearance services for each subscribing member. This includes but is not limited to business and practices that provide all services that enhance and promote beauty as a way of life. This includes: hair salons, nail salons, medical spas, wellness centers, physical fitness centers, spas, beauty clubs, cosmetics, estheticians, plastic surgeons, social workers, chiropractors, massage therapist, etc. It includes other practices that offer beauty services as a way of building on looks, self-esteem, and psychological being of an individual who is healthy in mind, spirit, and soul. The method and system employ a gambit of specific benefits as specific given approaches, which are defined as beauty care services under this capitation benefit program. The present system is a technology platform across the future of “cosmetology” in which a variety of beauty care process are implemented and used and interfaced with contractual arrangements with subscribers to this benefit package. This insurance plan and system will allow several changes to a unique beauty process to be adopted by and otherwise accommodate other processes dealing with the beauty care capitation system. Terms and agreement will be a part of the architecture of this document that leads to the creation of this insurance plan. Services that are provided under this insurance document and system are subscribed to and are considered service products.

From the foregoing it can be realized that the described method of the present invention may be easily and conveniently utilized as a business method for operating a salon-spa involving a salon-spa program. While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A method of operating a beauty salon-spa, the method comprising a salon-spa program, wherein a member of the salon-spa program signs a service agreement, pays a monthly fee for an effective period of the service agreement, and receives a salon-spa service package, comprising a plurality of salon-spa-related services, every month for the effective period.

2. The method according to claim 1, wherein the salon-spa publicly advertises to attract prospective members until the salon-spa obtains a pre-determined number of members of the salon-spa program, and the salon-spa stops publicly advertising to attract prospective members when the salon-spa obtains the pre-determined number of members of the salon-spa program.
